(19) United States
(12) Patent Application Publication
(10) Pub. No.: US 2017/0041715 A1
(43) Pub. Date: Feb. 9, 2017

(54) SPEAKER WITH COIL ANTENNA

(71) Applicant: Knowles Electronics (Beijing) Co., Ltd., Beijing (CN)

(72) Inventors: Karan Jumani, Schaumburg, IL (US); Lei Ma, Shanghai (CN)

(21) Appl. No.: 15/210,346

(22) Filed: Jul. 14, 2016

Related U.S. Application Data
(60) Provisional application No. 62/193,281, filed on Jul. 16, 2015.

(51) Int. Cl. H04R 9/06; H04R 3/04; H01Q 1/48; H01Q 1/36; H01Q 1/22; H04R 9/02; H04R 7/18

(52) U.S. Cl. CPC H04R 9/06; H04R 9/025; H04R 3/04; H04R 7/18; H01Q 1/36; H01Q 1/2291; H01Q 1/48

(57) ABSTRACT

A speaker is provided in which both audio signals and radio frequency (RF) signals are simultaneously fed to the coil of a speaker device causing the coil to drive the speaker's membrane producing sound and operate as an antenna for various electromagnetic frequencies. The speaker can be equipped with appropriate filter circuits to isolate the audio signals and RF signals within the speaker device.

### TECHNICAL FIELD

This application relates to speakers and, more specifically integrating antenna with speakers.

### BACKGROUND OF THE INVENTION

An antenna is a transducer that converts electrical signals on a device to radiated electromagnetic waves and vice-versa. It's dimensions, geometry, surrounding materials and the method of connections dictate the frequency range(s) (band(s)) in which the antenna works well (i.e. where the antenna resonates).

Speakers and receivers are devices that convert electrical signals into sound energy. Generally speaking, a speaker or receiver receives an electrical signal and converts the electrical signal into sound energy for presentation to the listener.

Speakers and receivers are often used in proximity to antennas in the same electronic device. For example, in cellular phones there is a speaker or receiver that presents sound to the ear of a listener. There are also antennas by which the cellular phone makes transmissions from the cellular phone to a cellular and/or other networks and vice versa (e.g., Bluetooth or WIFi networks). Personal computers, laptops, wearable device, and tablets also may have both speakers and antennas.

Speakers and receivers have been viewed as a hindrance to antenna performance. To mitigate the effect on antenna performance, speakers/receivers have either been kept at a distance from antennas or have been electrically choked by the use of inductors in their audio paths. These inductors allow low frequency signals (such as audio signals) to pass through almost perfectly intact but block radio frequency (RF) signals from crossing over from the speaker/receiver to the printed circuit board (PCB) or vice-versa. From the antenna's point of view, the speaker/receiver thus appears to be disconnected from the rest of the PCB and this improves the antenna's performance.

However, these approaches may increase system cost and result in larger devices. The problems of previous approaches have resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a side-cutaway view of a speaker according to various embodiments of the present invention;

FIG. 2 comprises a bottom view of a speaker according to various embodiments of the present invention;

FIG. 3 comprises a diagram of a speaker used with a printed circuit board (PCB), the PCB having additional circuitry according to various embodiments of the present invention;

FIG. 4 comprises a diagram of a speaker used with a dielectric according to various embodiments of the present invention;

FIG. 5 comprises a speaker used in a speaker box according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches utilize the coil in speakers/receivers as the antenna element. The speaker/receiver's coil may either form a part of a larger antenna or the entire antenna element itself. It may be used either in part or wholly as any type of antenna including but not limited to loop antennas, multi-turn loop antennas, helical antennas, or other examples of antennas.

In the present approaches, the coil of the speaker or receiver acts simultaneously (at the same time) as both a part of an acoustic transducer (its movement enables the generation of sound waves) as well as an antenna (radiating electromagnetic signals). To avoid electromagnetic signals (generally at higher frequencies) from going to the audio circuits and to avoid audio signals (generally at lower frequencies) from going to the electromagnetic circuits, filtering in each path is implemented.

In other aspects, various approaches are used to allow the coil of a speaker to resonate at any RF frequency range desired (such as those used in mobile phone communications—Bluetooth, WI-Fi, 3G, 2G, GSM, CDMA, LTE, to mention a few examples). Other examples are possible.

In one approach, the receiver's metallic composition is changed (changing the permeability of the material can result in a change in the coil's resonant frequency).

In another aspect, the size/shape/geometry of receiver coil is adjusted to make the receiver resonate at desired frequency.

In still another example, electrical circuits (e.g., involving the use of inductors, capacitors, resistors, impedance matching circuits, to mention a few examples) are either embedded in the receiver coil or connected to it (e.g. on a PCB) to adjust the resonance frequency of the coil and/or its radiation performance (efficiency).

In yet other aspects, switches (including but not limited to electronic, electrical, mechanical, MEMs switches), variable antenna matching circuits, or some combination of these may also be used to tune the resonant characteristics of the receiver to help it resonate across or within bands of interest.

In still other approaches, the receiver is placed next to a dielectric material (including but not limited to different plastics, ceramics, to mention a few examples) may also be used to alter the frequencies at which the receiver antenna can radiate. In one example, the membrane is made of a dielectric material and this composition has an effect on the resonant frequency of the antenna. The receiver/speaker may also be disposed in an assembly (such as in an integrated speaker assembly/box or an integrated receiver assembly/box).

In still other examples, the spatial location where the RF signal is fed onto the speaker/receiver coil and where a connection to ground is located are adjusted to adjust the frequency.

As used herein, the terms speakers and receivers are henceforth used interchangeably.

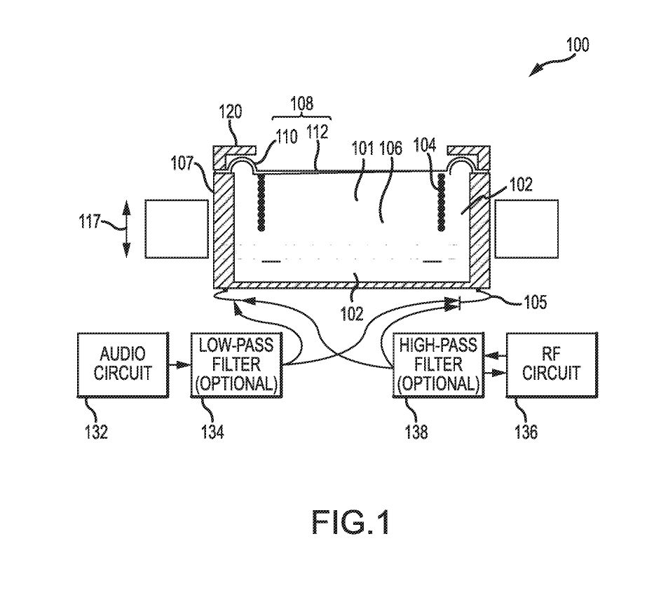

Referring now to FIG. 1, a speaker (or receiver) 100 includes a top plate 101, a pot or yoke 102, a speaker coil 104, speaker coil leads 105 (where RF and audio signals are fed), a magnet 106, a basket 107, a membrane 108 including a torous 110 and a dome 112, and a cover 120. An audio circuit 132 is connected to a low pass filter 134. An RF circuit 136 is connected to a high pass filter 138. This RF circuit can supply RF signals to be radiated, receive and process RF signals captured by the antenna or both.

The magnet 106 is used to produce a magnetic field. The top plate 101 is used to direct the magnetic flux. The coil is attached to a membrane 108 which is constructed of some flexible material. The pot 102 or yoke is constructed of a magnetic permeable material, for example, steel. The speaker coil 104 receives electrical signals via the speaker coil leads 105 including audio and RF signals. The basket 107 is used to enclose the other components. The cover 120 couples to the basket and further encloses the components.

The audio circuit 132 produces audio signals in the audio frequency range, for example 20 to 20 kHz (it can be extended further to the ultrasonic or lower into the infrasonic range). The low pass filter 134 is used to pass low frequencies below a predetermined low cutoff frequency but prevents signals at higher frequencies above the low cut-off frequency from flowing through.

The RF circuit 136 produces RF signals that are to be transmitted via an antenna to another entity, and also processes RF signals received via the antenna for example, in the cellular/WiFi/Bluetooth frequency range. The high pass filter 138 passes frequencies above a high cut-off frequency and prevents signals at frequencies below the high cut-off frequency from flowing through.

The coil 104 acts simultaneously as both a part of an acoustic transducer (its movement enables the generation of sound waves) as well as an antenna (radiating electromagnetic signals). In these regards, the RF circuit 136 sends electrical signals that pass through the high pass filter 138 to the coil 104 via speaker coil leads 105. Similarly, RF signals received by the coil 104 from an external source pass through the high pass filter 138 and get sent to the RF circuit 136. At the same time, the audio circuit 132 transmits other electrical signals through the low pass filter 134 to the coil 104 via speaker coil leads 105. Simultaneously, the electrical signals from the RF circuit 136 radiate from the coil 104, and the electrical signals from the audio circuit 132 cause a changing magnetic field moving the coil 104. The coil 104 is attached to the membrane 108 and consequently movement of the coil 104 moves the membrane 108 up and down in the direction of the arrow labeled 117. Movement of the membrane 108 creates sound, which can be presented to a user.

To avoid electromagnetic signals (generally at higher frequencies) from going to/reaching the audio circuit 132, the low pass filter 134 filters out high frequency signals originating at the RF circuit 136 and blocks these signals from reaching the audio circuit 132. To avoid audio signals (generally at lower frequencies) from going to/reaching the RF (electromagnetic) circuit 136, the high pass filter 138 filters out low frequency signals originating at the audio circuit 132 and blocks these signals from reaching the RF circuit 136.

In other aspects, the metallic composition of the speaker 100 (e.g., any component of the speaker 100 such as the basket 107) is changed (e.g., changing the permeability of the material can result in a change in the resonant frequency of the coil 104). Using a higher permeability material can help lower the frequency at which the coil resonates efficiently as an antenna.

In another aspect, the size/shape/geometry of the coil 104 is adjusted to make the receiver resonate at desired frequency. In general, using a coil with a larger perimeter will result in a lowering of its resonant frequency.

In still another example, electrical circuits (e.g., involving the use of inductors, capacitors, resistors, impedance matching circuits, to mention a few examples) are either embedded in the receiver coil 104 or connected to it to adjust the resonance frequency of the coil 104 or to improve its radiation capability.

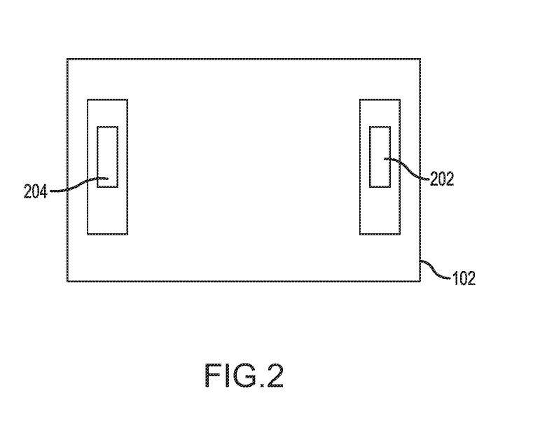

Referring now to FIG. 2, the bottom of the speaker pot 102 is described. As shown a first coil speaker lead 202 and a second speaker coil lead 204 extend through openings in the pot 102. The first coil speaker lead 202 may be an audio signal (from the audio circuit 132) and the RF feed from the RF circuit 136 after appropriate filtering. The second speaker coil lead 204 may be an audio signal (from the audio circuit 132) and RF ground after appropriate filtering. The signals over leads 202 and 204 may be swapped.

In still other examples, the spatial location where the RF signal is fed onto the speaker/receiver coil and where a connection to ground is located are adjusted to adjust the frequency.

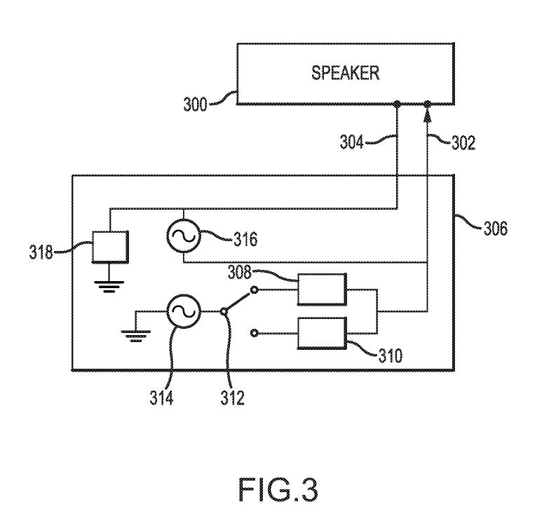

Referring now to FIG. 3, one example of circuitry used on a PCB is described. A speaker 300 is coupled to an RF feed and audio lead or line 302 and an RF ground and audio lead or line 304. The leads 302 and 304 connect to a printed circuit board (PCB) 306. The speaker 300 operates as described above with respect to speaker 100 described with respect to FIG. 1.

The PCB 306 includes two impedance matching circuits 308 and 310, a switch 312 to switch between the two matching circuits, a filtered RF signal 314 (that has been filtered to include high frequencies above a high cut-off frequency), a filtered low pass audio signal 316 (that has been filtered to include high frequencies above a high cut-off frequency), and a high pass filter 318. The signal 316 originates from an audio circuit (not shown) while the signal 314 originates from an RF circuit (not shown). The signal 314 is to be broadcast using the coil of the speaker 300 as an antenna, and simultaneously the signal 316 is used by the speaker 300 to produce audio sound for a listener. In some aspects, RF signals can also be received by the coil which converts them to electrical signals that can be processed by RF receivers. In such cases, 314 can also represent an RF receiver.

The circuits 308 and 310 may include various combinations of fixed or variable inductors, capacitors, resistors, or other impedance matching components to mention a few examples. Other examples are possible. The switch 312 may be used to select from the impedance matching circuits 308 or 310 to make the antenna (coil) resonate at different frequencies. Any number of impedance matching circuits may be used. The various components can be used to provide various functions such as matching the impedance of the antenna with that of the RF circuitry. Other examples of functions are possible.

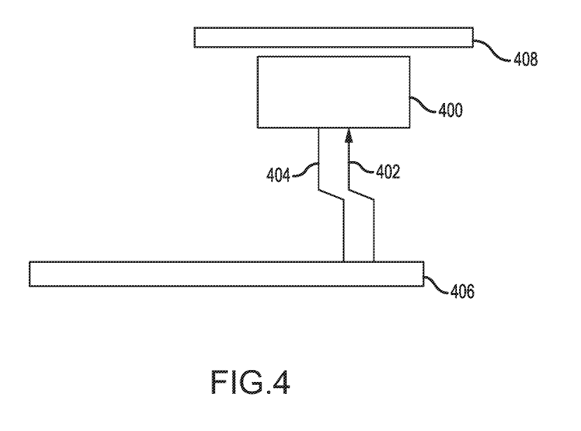

Referring now to FIG. 4, one example of a speaker used as part of a speaker box is described. A speaker 400 is coupled to an RF feed and audio lead or line 402 and an RF ground and audio lead or line 404. The leads 402 and 404 are connected to a printed circuit board (PCB) 406. The speaker 400 operates as described above with respect to speaker 100 of FIG. 1.

The speaker 400 is placed next to a dielectric material 408 (including but not limited to different plastics, ceramics, to mention a few examples) and this configuration is effective to alter the frequencies at which the receiver antenna (the coil of the speaker 400) can radiate effectively.

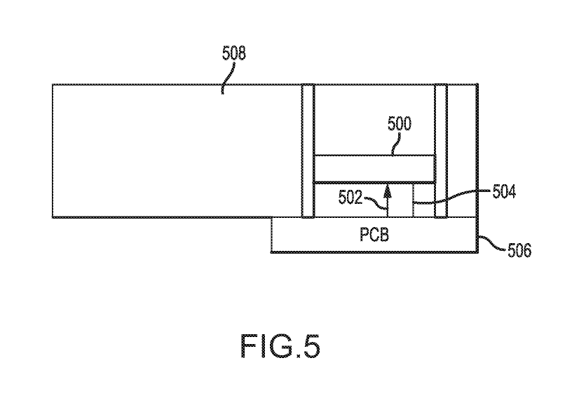

Referring now to FIG. 5, one example of a speaker 500 in a speaker box 508 is described. The speaker 500 is disposed in a speaker box 508. An RF feed and audio lead or line 502 and an RF ground and audio lead or line 504 couple to the speaker. The leads 502 and 504 are connected to a printed circuit board (PCB) 506. The speaker 500 operates as described above with respect to speaker 100 of FIG. 1.

The box 508 (or integrated assembly) may be used to hold other components such as antenna extensions. By integrated receiver assembly (or box), it is meant a receiver that is substantially integrated into an assembly or housing. The box 508 may be constructed in one example of plastic. Other examples of materials or combinations of materials may also be used.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A speaker device comprising:
a yoke;
a magnet disposed within the yoke;
a top plate disposed on one side of the magnet;
a coil surrounding the magnet, the coil configured for movement in a space between the yoke and the magnet;
a membrane connected to the coil;
a plurality of coil leads connected to the coil;
an audio circuit connected to the coil through the coil leads; and
a radio frequency (RF) circuit connected to the coil through the coil leads,
wherein the audio circuit generates audio signals that are delivered to the coil for the production of sound and the RF circuit generates RF signals that are delivered to the coil for the production of electromagnetic signals, the audio signals and RF signals being delivered to the coil simultaneously.

2. The speaker device of claim 1, further comprising a low pass filter connected between the audio circuit and the coil.

3. The speaker device of claim 1, further comprising a high pass filter connected between the RF circuit and the coil.

4. The speaker device of claim 1 wherein the RF circuit is further configured to receive external RF signals received by the coil.

5. The speaker device of claim 1 wherein the plurality of coil leads comprises a first coil lead and a second coil lead, wherein the first coil lead being connected to the audio signal from the audio circuit and to an RF feed from the RF circuit and wherein the second coil lead is connected to the audio signal from the audio circuit and to an RF ground of the RF circuit.

6. The speaker device of claim 5 further comprising at least two impedance matching circuits connected between the RF feed from the RF circuit and the first coil lead and at least one switch configured to switch between the at least two impedance matching circuits.

7. The speaker device of claim 1, further comprising a dielectric material located in proximity to the coil and configured to alter the frequencies at which the coil effectively radiates electromagnetic waves.
